(19) United States
(12) Patent Application Publication
(10) Pub. No.: US 2024/0266763 A1
(43) Pub. Date: Aug. 8, 2024

(54) CONDUCTOR CONNECTION TERMINAL

(71) Applicant: WAGO Verwaltungsgesellschaft mbH, Minden (DE)

(72) Inventor: Michael MEYER, Wiedensahl (DE)

(73) Assignee: WAGO Verwaltungsgesellschaft mbH, Minden (DE)

(21) Appl. No.: 18/605,793

(22) Filed: Mar. 14, 2024

Related U.S. Application Data
(63) Continuation of application No. PCT/DE2022/100667, filed on Sep. 9, 2022.

(30) Foreign Application Priority Data
Sep. 15, 2021 (DE) 10 2021 123 890.0

(51) Int. Cl. H01R 9/24; H01R 9/16

(52) U.S. Cl. CPC H01R 9/2408; H01R 9/16; H01R 9/2475

(57) ABSTRACT

A conductor connection terminal with a conductor terminal connection arranged in a housing that has a first end face designed as conductor insertion side, with at least one conductor insertion opening, and a second end face, which lies opposite the first end face, a first side face and a second side face, which lies opposite the first side face. The two side faces connect the first and the second end face to each other, and a bottom face and a top face which lies opposite the bottom face and which connects the two end faces and the two side faces to each other. A first form-fit element and a second form-fit element, spaced apart from the first form-fit element, are arranged at least on the first side face, wherein the two form-fit elements have two contours which differ from each other and which are designed to complement each other.

This nonprovisional application is a continuation of International Application No. PCT/DE2022/100667, which was filed on Sep. 9, 2022, and which claims priority to German Patent Application No. 10 2021 123 890.0, which was filed in Germany on Sep. 15, 2021, and which are both herein incorporated by reference.

### BACKGROUND OF THE INVENTION

### Field of the Invention

The invention relates to a conductor connection terminal with a conductor terminal connection arranged in a housing, wherein the housing has a first end face designed as a conductor insertion side with at least one conductor insertion opening and a second end face opposite the first end face and a first side face and a second side face opposite the first side face, wherein the two side faces connect the first and second end faces to each other. The housing also has an underside and a top side opposite the underside, which connect the two end faces and the two long sides.

### Description of the Background Art

DE 40 03 701 A1, which corresponds to U.S. Pat. No. 5,098,316, which is incorporated herein by reference, discloses a connection terminal formed of two single pole terminals assembled by means of interlocking linear dovetail guides. The dovetail guides extend along the side walls of the housing of the connection terminal transversely to the conductor insertion direction.

### SUMMARY OF THE INVENTION

It is therefore an object of the invention to specify a conductor connection terminal that is as far improved as possible and a conductor connection terminal arrangement with the most extended functionality possible.

In the case of a conductor connection terminal with a conductor terminal connection arranged in a housing, wherein the housing has a first end face designed as a conductor insertion side with at least one conductor insertion opening and a second end face opposite the first end face, as well as a first side face and a second side face opposite the first side face, wherein the two side faces connect the first and second end faces, as well as an underside and a top side opposite the underside, which connect the two end faces and the two side faces with each other, it is proposed according to the invention that at least on the first side face a first form-fitting element and a second form-fitting element spaced from the first form-fitting element are arranged, wherein the two form-fitting elements have two contours that are different from each other, which are complementary to each other, i.e., the form-fitting elements are formed in such a way that the form-fitting elements have mutually complementary contours which can be brought into contact with each other in a form-fitting manner.

The two form-fitting elements can be set up to interact with at least one complementary first form-fitting element and at least one second complementary form-fitting element of at least one second conductor connection terminal. This example creates an advantageous stable form-fitting connection with which at least one other second conductor connection terminal or another component, such as a fastener, can be easily connected to the conductor connection terminal. For this purpose, the second conductor connection terminal or other component has form-fitting elements that are complementary to the conductor connection terminal. The different design allows for the further second conductor connection terminal or the other component to be connected in the correct position.

The form-fitting elements can extend transversely to a longitudinal direction of the side faces extending between the end faces. The form-fitting elements are preferably aligned at least predominantly perpendicular to the longitudinal direction. As a result, for example, conductor tensile forces can be advantageously absorbed by the form-fitting connection.

The first form-fitting element can be designed as a protrusion protruding from the side face, and the second form-fitting element is designed as a depression that is complementary to the protrusion. Accordingly, the depression matches the protrusion to create the form-fit. Preferably, the protrusion has a T-shaped or dovetail-like cross-sectional contour, wherein the depression has a complementary T-shaped or dovetail-like cross-sectional contour. In the direction of a perpendicular to the plane of the side face, form-fitting undercuts are thus present. This advantageously also ensures a form-fit in the direction of a perpendicular to the plane of the side face. The different design of the two form-fitting elements also allows for direction-independent mounting of two conductor connection terminals to each other.

A fastening section can be arranged between the first and second form-fitting elements for fastening the conductor connection terminal. This fastening section is used to attach the conductor connection terminal to a mounting plate, a DIN rail or similar, for example. A separate fastener, such as a snap-in mounting foot, can preferably be arranged on the fastening section. In an example, the fastening section is designed as a gutter-shaped depression. Preferably, the depression is trough-shaped or semi-circular or semi-cylindrical. The depression preferably extends over the entire height transversely to the longitudinal extension of the side face or only over part of the height. The depression does not need to be uniformly developed but may also have protrusions or the like. Alternatively, the fastening section can also be designed only as a limited depression, for example a hole-shaped snap-in mount.

A third form-fitting element and a fourth form-fitting element can be arranged on the second side face, wherein the third form-fitting element is point-symmetrical to the first form-fitting element and the fourth form-fitting element is symmetrical, in particular point-symmetrical to the second form-fitting element relative to a symmetry axis aligned in parallel to the side face and transverse to the longitudinal extension of the conductor connection terminal. The first and third form-fitting elements on the one hand and the second and fourth form-fitting elements on the other hand preferably have an identical cross-sectional contour. This example makes it possible to connect further conductor connection terminals or other components, such as fasteners, to the conductor connection terminal on both sides. The point-symmetrical arrangement of the differently designed form-fitting elements advantageously enables the conductor connection terminals to be mounted together independent of direction. This is particularly advantageous if the conductor connection terminal has conductor insertion openings on both opposing end faces.

The depression can be formed by two raised and spaced ribs arranged on the side face. This means that the depression does not extend into the interior of the housing but is formed on the side face. The interior space is thus advantageously not restricted.

A stop can be provided on the side face, which limits the insertion of the protrusion into the depression. This makes it easy for the operator to mount two conductor connection terminals or other components with a defined end position. In this end position, the base surfaces of the two respective conductor connection terminals advantageously form a common plane or are arranged in a common plane, which can form a common contact surface.

The ribs can extend wedge-shaped to each other, at least in sections, and/or the protrusion is wedge-shaped, at least in sections. A design of this type allows the operator a simplified assembly, as the protrusion can be threaded or inserted into the depression more easily. It is therefore advantageous if the wedge-shaped course, at least in sections, is at least available in an insertion section. The wedge-shaped course of the ribs and the protrusion can also be used to form a stop for the limitation of the insertion depth.

Another aspect of the invention is a conductor connection terminal arrangement with a first conductor connection terminal and a second conductor connection terminal. The first conductor connection terminal and the second conductor connection terminal are connected to each other via the interlocking of the first form-fitting element of the first conductor connection terminal with the second form-fitting element of the second conductor connection terminal, which is complementary to the first form-fitting element, and the second form-fitting element of the first conductor connection terminal, which is complementary to the second form-fitting element. This results in a particularly stable form-fitting connection in a series line-up direction of the conductor connection terminals, wherein the series line-up direction is defined by essentially a perpendicular to the side faces. If the first and second form-fitting elements are designed differently on each side face of the conductor connection terminal in a further development, the conductor connection terminals can be advantageously mounted and connected to each other independent of direction.

The fastener of the first conductor connection terminal, preferably designed as a gutter-shaped depression, and a fastener of the second conductor connection terminal, which is designed as a gutter-shaped depression, are located opposite each other and form a circumferential mount. The circumferential mount is at least mostly closed, wherein narrow gaps may remain at the point of contact of the side faces of the conductor connection terminals, but this is not mandatory. The circumferential mount is advantageous for accommodating a snap-in mounting foot, a screw or a marking carrier, for example.

More than two conductor connection terminals can be connected to each other, advantageously resulting in a string of conductor connection terminals.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor connection terminal in an example in a three-dimensional view;

FIG. 2 shows a conductor connection terminal arrangement with a first and a second conductor connection terminal in an example with a snap-in mounting foot;

FIG. 3 shows a conductor connection terminal arrangement from FIG. 2 in a top view;

FIG. 4 shows a conductor connection terminal arrangement from FIG. 3 with a partial section X;

FIG. 5 shows the partial section X from FIG. 4 in an enlarged representation;

FIG. 6 shows the conductor connection terminal arrangement in a sectional representation along the cutting line A-A from FIG. 3; and

FIG. 7 shows a conductor connection terminal arrangement with a first and a second conductor connection terminal in an example with an marking carrier

### DETAILED DESCRIPTION

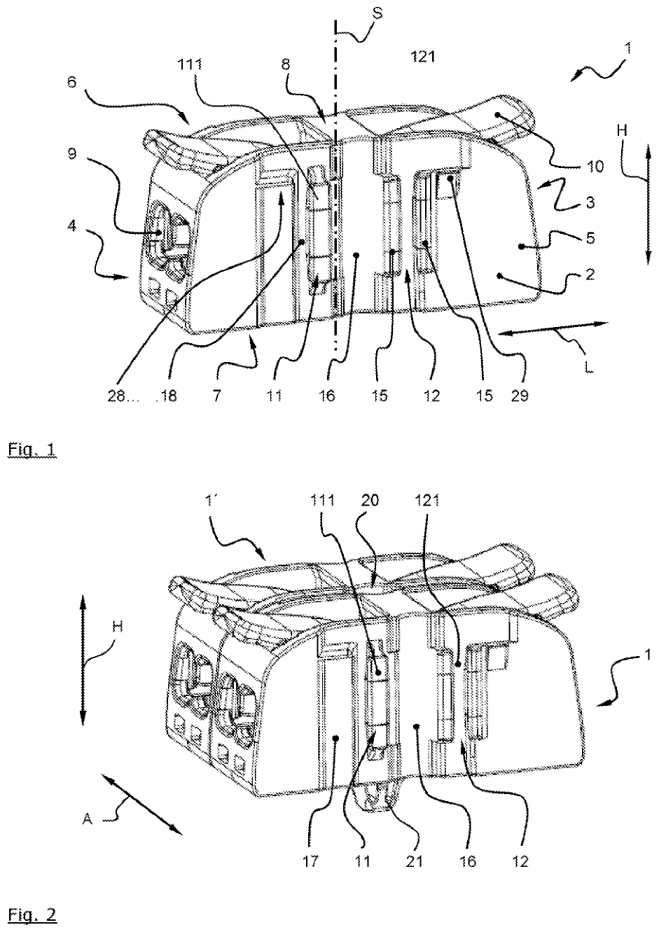

FIG. 1 shows an example of a conductor connection terminal 1. The conductor connection terminal 1 has a housing 2 with a first end face 3 and a second end face 4 opposite the first end face 3. The two end faces 3, 4 are connected to each other via a first side face 5 and a second side face 6 opposite the first side face 5. Further, the housing 2 has an underside 7 and a top side 8, wherein the top side 8 is located opposite the underside 7. The underside 7 and the top side 8 connect the two end faces 3, 4 as well as the two side faces 5, 6 with each other. The extension from the first end face 3 to the second end face 4 or vice versa defines a longitudinal direction L of the conductor connection terminal 1.

On the first and second end faces 3, 4 there is at least one conductor insertion opening 9, above which an electrical conductor, not shown, can be fed to a conductor terminal, which is arranged in the housing 2 of the conductor connection terminal 1 and not shown in more detail. For example, the respective conductor terminal is designed as a spring-loaded terminal connection with a deflectable clamping spring, wherein the clamping spring or each of the clamping springs can be operated by the actuating lever 10 arranged, for example, on the top side 8 of the housing 2.

FIG. 1 also shows two form-fitting elements 11, 12 on the first side face 5, wherein a first form-fitting element 11 is formed as a protrusion 111. The second form-fitting element 12 has a depression 121. For example, the depression 121 can be formed by two ribs 15 protruding from the first side face 5. The two form-fitting elements are complementary to each other. The form-fitting elements 11, 12 have an extension in a vertical direction H that is essentially perpendicular to the longitudinal extension L. In this case, the form-fitting elements 11, 12 do not extend over the entire height H1 of the side face 5, but only over part of the height H1. For example, the form-fitting elements 11, 12 are spaced from the underside 7 and the top side 8. The advantage of this design is that the mounting distance or displacement distance between the conductor connection terminal 1 and another conductor connection terminal can be kept relatively small.

Between the first form-fitting element 11 and the second form-fitting element 12, a fastener 16 is also arranged, for example in the form of a gutter-shaped depression.

On the second, non-visible side face 6, there is a form-fitting element 13, which is also not visible and is formed as a protrusion 131, and a fourth form-fitting element 14, which is formed as a depression 141. The third form-fitting element 13 is also complementary to the fourth form-fitting element 14. The first form-fitting element 11 is preferably arranged point-symmetrically to the third form-fitting element 13 relative to an axis of symmetry S aligned perpendicular to the longitudinal direction L and parallel to the side faces 5, 6. Furthermore, the second form-fitting element 12 is arranged point-symmetrically to the fourth form-fitting element 14 relative to the axis of symmetry S. At a distance from the protrusion 111, 131, a boundary wall 17 is provided, which, together with the protrusion 111, 131, forms a further depression 18, which is suitable for accommodating a rib 15 of another conductor connection terminal. By means of the boundary wall 17, a lateral boundary of the depression 18 can be achieved in a simple way without increased effort.

On the second side face 6, between the third form-fitting element 13 and the fourth form-fitting element 14, a further fastener 19 is also arranged, for example in the form of a gutter-shaped depression.

The underside 7 of the housing 2 can preferably be flat and it serves advantageously as a support on a mounting plane that is not shown. It is also conceivable that depressions or snap-in hooks are provided on the underside, by means of which the conductor connection terminal 1 can be attached to a mounting plane.

FIGS. 2 to 5 show an inventive conductor connection terminal arrangement with a first conductor connection terminal 1 and a second conductor connection terminal 1′ in an example, wherein the first conductor connection terminal 1 and the second conductor connection terminal 1′ may be essentially identical. In particular, both conductor connection terminals 1, 1′, each have a first, a second, a third and a fourth form-fitting element 11, 12, 13, 14. The first form-fitting element 11 of the first conductor connection terminal 1 interacts with the complementary fourth form-fitting element 14′ of the second conductor connection terminal 1′; in particular, the form-fitting elements 11, 14′ are connected to each other in a form-fitting manner. The second form-fitting element 12 of the first conductor connection terminal 1 interacts with the complementary third form-fitting element 13′ of the second conductor connection terminal 1; in particular, the form-fitting elements 11, 14′, are connected to each other in a form-fitting manner. The first and the second conductor connection terminal 1, 1′, are connected to each other by inserting the form-fitting elements 11, 14′, 12, 13′, in the vertical direction H, so that they are form-fittingly connected to each other in a direction of alignment A, which is oriented perpendicular to the longitudinal direction L and perpendicular to the vertical direction H (perpendicular to the planes of the side faces 5, 6). The two conductor connection terminals 1, 1′, preferably form a common support plane with their undersides 7, 7′. This can be achieved, for example, by providing a stop 28, 29 on one or both side faces 5, 6, which limits the insertion of a protrusion 111, 131 into a depression 121, 141. For example, two complementary protrusions 28, 29 protruding from the side face 5, 6, which are each provided with a mutually aligned stop surface perpendicular to the vertical direction H, are provided as a stop.

FIG. 2 also shows that the fasteners 16′, 19 of the first conductor connection terminal 1 and the second conductor connection terminal 1′, which are formed as a gutter-shaped depressions and are opposite each other in the assembled state, form a circumferential predominantly closed mount 20. For example, a snap-in mounting foot 21 can be inserted into the mount 20, which protrudes on the underside 7 of the conductor connection terminals 1, 1′. For example, the end of the snap-in mounting foot 21 protruding on the underside 7 of the conductor connection terminal can be inserted into a snap-in opening of a mounting plate that is not shown and snapped into place there to fix the conductor connection terminal arrangement to the mounting plate.

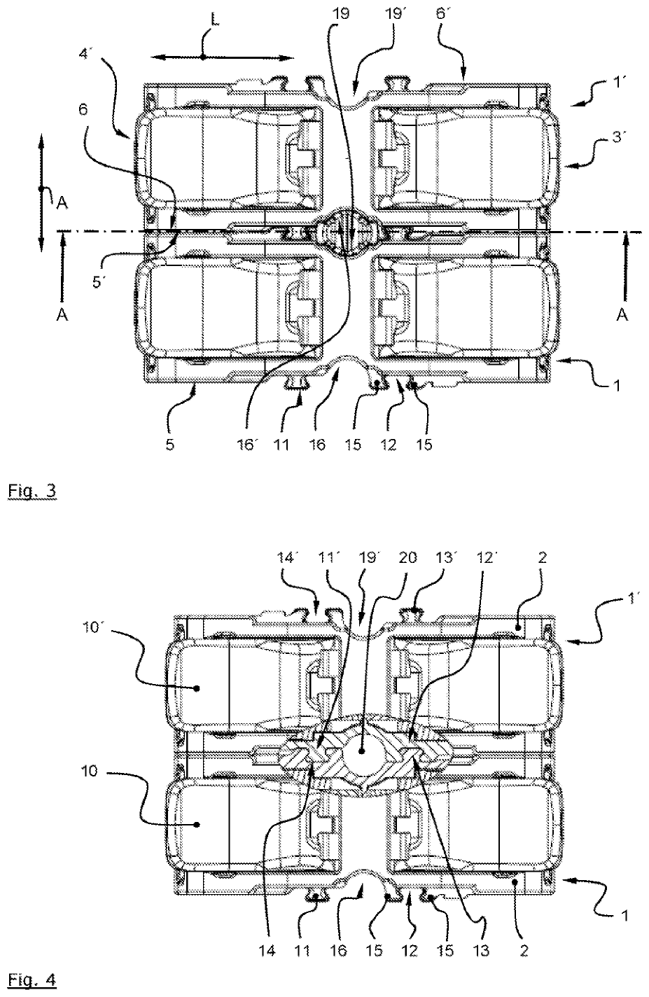

FIGS. 3 and 4 each show a top view of a conductor connection terminal arrangement formed of a first conductor connection terminal 1 and a second conductor connection terminal 1′. In particular, it can be seen that the circumferential mount 20, which is preferably circular at least over a section in the vertical direction H, is formed from the fasteners 16, 19 opposing each other. The fasteners 16′, 19 each have a semi-circular gutter-shaped depression for this purpose. However, it is also conceivable that the cross-sectional shape of the mount 20 deviates from the circular shape, and is, for example, square, rectangular or star-shaped.

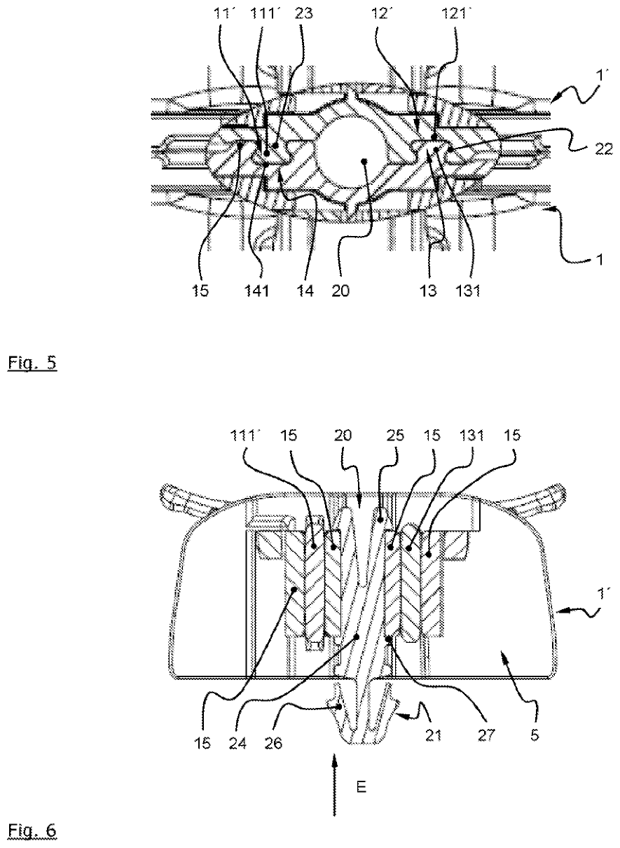

The section shown in FIG. 5 illustrates once again the form-fitting connection of a first conductor connection terminal 1 and a second conductor connection terminal 1′. It becomes clear that the first form-fitting element 11 of the first conductor connection terminal 1 and the third form-fitting element 13′ of the second conductor connection terminal 1′ each have a dovetail-like or T-shaped cross-sectional contour. The protrusions 111, 131′ protruding from the side faces 5, 6′, have sections 22 protruding longitudinally in opposite directions in an area distanced from the side face 5, 6′, which are connected to the side face via a rib section 23. In this way, a contour with an undercut is realized, which can be brought into engagement with a complementary mount contour of the corresponding fourth form-fitting element 14′ of the second conductor connection terminal 1′ and the corresponding second form-fitting element 12 of the first conductor connection terminal 1. The contours of the form-fitting elements 11, 12, 13′, 14′ can be rounded.

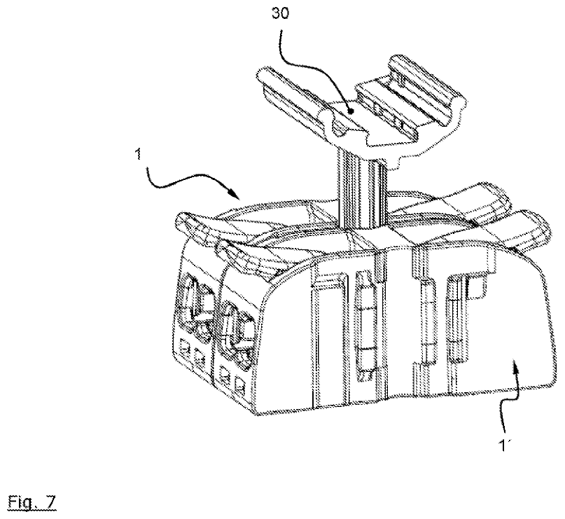

The sectional view in FIG. 6 shows a section through the dividing plane of a first conductor connection terminal 1 and a second conductor connection terminal 1′, with a view of the side face 5′ of the second conductor connection terminal 1′. The cut protrusion 111′ can be seen here of the first form-fitting element 11′ of the second conductor connection terminal 1′, as well as the cut protrusion 131 of the third form-fitting element 13 of the first conductor connection terminal 1. The protrusions 111′, 131 are surrounded in the longitudinal direction L by two ribs 15 each of the respective complementary fourth form-fitting element 14 and the second form-fitting element 12 of the first conductor connection terminal 1.

FIG. 6 also shows a snap-in mounting foot 21 inserted and mounted in the mount 20 with a preferably essentially cylindrical base body 24, which on the one end first has snap-in hooks 25 that can be deflected resiliently, which are suitable for locking with counter snap-in sections on the housing of the conductor connection terminals 1, 1′. On the other end, when assembled, the snap-in mounting foot 21 has a second, preferably resiliently deflectable snap-in hook 26 that protrudes from the underside 7, 7′ of the conductor connection terminal arrangement. The second snap-in hooks 26 are suitable for attaching the conductor connection terminal arrangement to a mounting plate with a snap-in opening that is not shown.

The snap-in mounting foot 21 is preferably inserted into the mount 20 from the underside 7, 7′, of the conductor connection terminal arrangement in a plug-in direction E. A stop 27 on the base body 24 of the snap-in mounting foot 21 interacting with the housing shoulder limits the insertion depth and enables a defined position of the snap-in mounting foot. The housing shoulder can preferably be formed by the ribs 15.

Such a conductor connection arrangement can be extended via the form-fitting elements 11, 12, 13, 14 with any number of other conductor connection terminals 1. The conductor connection terminals do not always have to be identical or of the same design, but they can differ from each other in terms of size, shape and/or type of conductor connection, for example. It is only necessary to have corresponding form-fitting elements 11, 12, 13, 14 on the conductor connection terminals 1 that are to be connected to each other. The various conductor connection terminals 1 can be mounted together independent of the direction.

FIG. 7 shows another example of a conductor connection terminal arrangement with a first and a second conductor connection terminal 1, 1′, wherein in the mount 20 formed here, a marking carrier 30 is inserted for the inclusion of markings that are not shown.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor connection terminal comprising a conductor terminal connection arranged in a housing, the housing comprising:
a first end face designed as a conductor insertion side with at least one conductor insertion opening and a second end face located opposite the first end face;
a first side face and a second side face, which is opposite the first side face, the first and second side faces connect the first and second end faces with each other;
an underside and a top side located opposite the underside, which connects the first and second end faces and the first and second side faces with each other;
a first form-fitting element arranged at least on the first side face;
a second form-fitting element arranged at a distance from the first form-fitting element, the first and second form-fitting elements having two contours that are different from each other and which are complementary to each other.

2. The conductor connection terminal according to claim 1, wherein the first and second form-fitting elements are set up to interact with at least one complementary first form-fitting element and at least one second complementary form-fitting element of at least one second conductor connection terminal.

3. The conductor connection terminal according to claim 1, wherein the first or second form-fitting elements extend transversely to a longitudinal direction of the side faces extending between the end faces.

4. The conductor connection terminal according to claim 1, wherein the first form-fitting element is designed as a protrusion protruding from the side face, and the second form-fitting element is formed as a depression corresponding or complementary to the protrusion.

5. The conductor connection terminal according to claim 1, wherein a fastening section is arranged between the first and the second form-fitting element for fastening the conductor connection terminal.

6. The conductor connection terminal according to claim 5, wherein the fastening section is designed as a gutter-shaped depression.

7. The conductor connection terminal according to claim 1, wherein on the second side face, a third form-fitting element and a fourth form-fitting element that is complementary to the third form-fitting element are arranged, wherein the third form-fitting element is arranged point-symmetrically to the first form-fitting element and the fourth form-fitting element is arranged point-symmetrically to the second form-fitting element relative to an axis of symmetry oriented transversely to the longitudinal extension and parallel to the side face.

8. The conductor connection terminal according to claim 1, wherein the depression is formed by two raised and spaced ribs arranged on the side face.

9. The conductor connection terminal according to claim 1, wherein a stop is provided on the side face which limits the insertion of the protrusion into the depression.

10. The conductor connection terminal according to claim 1, wherein the ribs extend in a wedge-shaped manner, at least in sections, and/or the protrusion is wedge-shaped.

11. The conductor connection terminal according to claim 4, wherein on the side of the protrusion, at least on one side, a boundary wall is arranged on the side face.

12. A conductor connection terminal arrangement comprising:
at least one first conductor connection terminal; and
at least one second conductor connection terminal, the first and second conductor connection terminal each being the conductor connection terminal according to claim 1,
wherein the first conductor connection terminal and the second conductor connection terminal are connected to each other via an interlocking of the first form-fitting element of the first conductor connection terminal with the second form-fitting element of the second conductor connection terminal, which is complementary to the first form-fitting element, and the second form-fitting element of the first conductor connection terminal with the first form-fitting element of the second conductor connection terminal, which is complementary to the second form-fitting element.

13. The conductor connection terminal arrangement according to claim 12, wherein the fastener of the first conductor connection terminal and the fastener of the second conductor connection terminal are opposite each other and form a circumferential mount.

14. The conductor connection terminal arrangement according to claim 12, wherein more than two conductor connection terminals are connected in series.
